(19) United States
(12) Patent Application Publication
(10) Pub. No.: US 2005/0043468 A1
(43) Pub. Date: Feb. 24, 2005

(54) Hot melt pressure sensitive adhesive composition for providing water-tight joints in single-ply roofing membranes

(76) Inventor: Dennis K. Fisher, Brooklyn, MI (US)

Correspondence Address: DINSMORE & SHOHL LLP, Suite 500, One Dayton Centre, Dayton, OH, 45402-2023, US

(21) Appl. No.: 10/643,047

(22) Filed: Aug. 18, 2003

(51) Int. Cl. C08L 1/00

(52) U.S. Cl. 524/502

(57) ABSTRACT

An adhesive composition is provided for adhering together roofing materials such as EPDM rubber and thermoplastic polyolefin (TPO). The adhesive composition includes a rubbery polymer comprising a blend of a thermoplastic block copolymer and a polyisobutylene. The adhesive composition may further include a compatible tackifier and an amorphous polyolefin. The composition is a pressure sensitive adhesive which can be applied to roofing materials in a peel and stick manner and provides a long term, water-tight seal and high bond strength.

### BACKGROUND OF THE INVENTION

The present invention relates to an adhesive composition for providing a water-tight seal to joints of overlapping or spliced roofing membrane sheets. More particularly, the present invention relates to an adhesive composition that is pressure sensitive and may be applied to a roofing membrane in a peel and stick manner.

Roofing materials such as ethylene-propylene-diene terpolymer (EPDM), butyl rubber, neoprene, polyvinyl chloride, chlorinated polyethylene, thermoplastic polyolefin (TPO) and modified bitumen and the like are often used as single-ply roofing membranes because they are well known in the art as having barrier properties against moisture. Such roofing materials are typically overlapped and/or spliced together with an adhesive to form a continuous, water-tight sheet which covers a roof area. In use, the roofing materials may be exposed to stresses such as roof movement, heavy winds, freeze-thaw cycles and thermal cycles. Therefore, the adhesive must be able to withstand such possible stresses.

Currently, roofing membranes are adhered together utilizing a variety of methods. One such method involves the use of liquid based adhesives that employ natural and/or synthetic elastomers and resins in organic solvent systems. These liquid based adhesives do not always provide good bond strength and long-term durability. For example, if conditions during application are windy, dust or other debris may adhere to the adhesive and impair the quality of the bond. High temperatures may cause the adhesive to dry out too quickly. These environmental problems may complicate installation procedures. Additionally, liquid based adhesives often utilize organic solvents such as toluene and xylene. These solvents pose a health and fire hazard, and their use is undesirable.

Other methods of adhering roofing membranes include the use of slow drying water based adhesives. Additionally, asphalt based adhesives that must be heated to a molten state and then swabbed onto the roofing material surface may also be used. However, these asphalt adhesives require special equipment and can pose a fire risk. Heat welding of thermoplastic materials and nailing have also been utilized to secure roofing membranes together. These processes may be extremely time consuming, hazardous, or provide an inferior seam.

Thus, there is a need for an adhesive composition which can be used to adhere together sheets of roofing membranes which provides a long term, water-tight seal and high bond strength. Additionally, the adhesive should pose no environmental hazard.

### SUMMARY

The present invention meets that need by providing a hot melt pressure sensitive adhesive composition for adhering together roofing materials such as synthetic EPDM rubbers or TPO and which provides long term water tightness. The adhesive composition may be applied in a peel and stick manner, and poses no environmental hazard.

In accordance with one embodiment of the invention, the adhesive composition includes a) a rubbery polymer comprising a blend of i) from about 10% to about 25% by weight of a thermoplastic block copolymer selected from the group consisting of a styrene-butadiene-styrene block copolymer, a styrene-isoprene-styrene block copolymer, a styrene-ethylene/butylene-styrene block copolymer, a styrene-ethylene/propylene block copolymer and an ethylene-propylene block copolymer and combinations thereof and ii) from about 5% to about 20% by weight polyisobutylene; b) a compatible tackifier; and c) an amorphous polyolefin.

In a preferred embodiment of the invention, the thermoplastic block copolymer comprises from about 15 to about 20% by weight of the total adhesive composition, and the polyisobutylene comprises from about 10 to about 15% by weight of the total adhesive composition.

The tackifier is preferably selected from the group consisting of hydrogenated polyalicyclic resins, aliphatic hydrocarbon resins, aromatic hydrocarbon resins, coumarone indene resins, esters of hydrogenated rosins, and blends and combinations thereof.

The amorphous polyolefin is preferably selected from the group consisting of amorphous polypropylene-ethylene copolymers, amorphous polypropylene/polypropylene-ethylene copolymers, amorphous polypropylene homopolymers, amorphous polyethylene homopolymers, and blends and combinations thereof.

The adhesive composition may further comprise butyl rubber. The composition preferably further includes a compatible plasticizer. The plasticizer is preferably selected from the group consisting of polybutene, chlorinated paraffin, and blends and combinations thereof.

The composition may also include minor portions of other additives including antioxidants, coloring pigments, reinforcing agents, dessicants, and flame retardants.

In accordance with another embodiment of the invention, a first roofing membrane is sealed to a second roofing membrane with an adhesive composition to provide a water-tight seal, where the adhesive composition comprises a) a rubbery polymer comprising a blend of i) a thermoplastic block copolymer selected from the group consisting of a styrene-butadiene-styrene block copolymer, a styrene-isoprene-styrene block copolymer, a styrene-ethylene/butylene-styrene block copolymer, a styrene-ethylene/propylene block copolymer and an ethylene-propylene block copolymer and combinations thereof and ii) a polyisobutylene; and b) a compatible tackifier, where the adhesive composition preferably exhibits a 180° peel strength at room temperature of at least 1270 grams/in (500 grams/cm). The adhesive composition also preferably supports a static load of at least 50 grams/in² (8 g/cm²) at 70° C. for at least 96 hours when adhered to a substrate.

The present invention provides an adhesive composition with excellent tack and quick stick properties. The adhesive resists extreme heat and cold. Additionally, the adhesive may be used to adhere roofing materials such as EPDM rubber or TPO to provide a watertight seal. The adhesive may be used in a variety of weather conditions, and no special equipment is required. Additionally, the adhesive poses no environmental hazard and does not require hazardous solvents.

Accordingly, it is a feature of the present invention to provide an adhesive composition for use in adhering together roofing materials which provides ease of application, good strength, and a long term water tight seal. These, and other features and advantages of the present invention will become apparent from the following detailed description and the appended claims.

### DETAILED DESCRIPTION OF THE PREFERRRED EMBODIMENTS

The present invention provides a pressure sensitive adhesive composition for adhering together roofing materials. The adhesive composition may be applied to roofing materials in a peel and stick manner while providing a water-tight seal, weathering resistance, and low temperature properties.

The adhesive composition of the present invention preferably comprises a rubbery polymer comprising a blend of a thermoplastic block copolymer and a polyisobutylene. For example, the block copolymer may be a polymer of styrene-butadiene-styrene type such as Kraton D1101, D1102, D1116, D1118, D1122, D1184 or D1300, all available from Kraton polymers; or Calprene C-401, C-411, C-411X, C-412, C-416, 419, 484, 485,487, 500 or 501, commercial products available from Dynasol. The block copolymer may be a polymer of a styrene-isoprene-styrene type such as Kraton D1107, D1111, D1112, D1113, D1117, D1119, D1124, D1125, D1193 or D1320, commercial products available from Kraton Polymers; or KTR-801 or KTR-802, available from Momentum Technologies. The block copolymer may be polymer of a styrene-ethylene-butadiene-styrene type such as Kraton G1650, G1651, G1652, G1654, G1657, G1726, G7723 or GRP6919, commercial products available from Kraton Polymers; or Calprene H-6110, 6120, 6140 or 6170, all available from Dynasol. The block copolymer may be a polymer of a styrene-ethylene-propylene type such as Kraton G1701 or G1702, commercial products available from Kraton Polymers. The block copolymer may be a polymer of an ethylene-propylene type such as Kraton G1750 or G1765, commercial products available from Kraton Polymers. Additionally, the block copolymer component may be a combination of such copolymers. Generally, the adhesive composition will include from about 10% to about 25% by weight of the block copolymer. More preferably, the adhesive composition will contain from about 15 to 20% by weight of the block copolymer.

The polyisobutylene of the present adhesive composition may be a high molecular weight polyisobutylene such as Vistanex L-80, L-100, L-120 or L-140, commercial products available from ExxonMobil Chemical; or Oppanol B-30, B-50, B-80, B-100, B-150 or B-200, available from BASF Corporation. The polyisobutylene of the present adhesive composition may also be a low molecular weight polyisobutylene such as CP-24, LM-MS, LM-MH, LM-H or LM-S, all available from ExxonMobil Chemical; or Opponol B-10, B-12, B-13 or B-15, commercial products available from BASF corporation; or P-12 or P-15, products available from Alcan Rubber and Chemical; or 4.0H, 4.5H, 5.0H, 5.5H or 6HT, commercial products available from Rit-Chem. Additionally, the polyisobutylene component may be a combination of such polyisobutylenes. Generally, the polyisobutylene component comprises from about 5% to about 20% by weight of the adhesive composition. More preferably, the polyisobutylene component comprises about 10% to about 15% by weight of the adhesive composition.

The adhesive composition may further include butyl rubber. The butyl rubber may include, for example, Exxon 065, 077, 165, 068, 268, or 269, commercially available from ExxonMobil. Other suitable butyl rubbers include PB-100, PB-101-3, PB-200, PB-301 or PB-402, commercially available from Bayer Corporation. The butyl rubber preferably comprises from about 3% to about 8% by weight of the adhesive composition.

The adhesive composition preferably contains a compatible tackifier that is generally a tackifying resin. The tackifying resin gives the composition its softness and high initial adhesivity. The resin may be a hydrogenated polyalicyclic resin such as P-95, P-115, P-125 or P-140, commercial products available from Arakawa Chemical; or Escorez 5380, 5300, 5320 or 5340, commercial products available from ExxonMobil Chemical; or Regalite R91, R101, R125 or S260 or Regalrez 1018, 1085, 1094, 1126, 1128, 1139, 3102, 5095 or 6108, products available from Hercules; or Eastotac H-100W, H-115W or H-130W, all available from Eastman Chemical; or Sukorez SU-100, SU-110, SU-120 or SU-130, commercial products available from Kolon Chemical. The resin may also be an aliphatic hydrocarbon resin such as Escorez 1102, 1304, 1310LC, 1315 or 1504, commercial products available from ExxonMobil Chemical; or Nevtac 10, 80, 100 or 115, products available from Neville Chemical; or Wingtack 10, 95 or Plus, all available from Goodyear Tire & Rubber; or Eastotac H-100E, H-100R, H-100L, H-115E, H-115L, H-130E, H-130R or H-130L, commercial products available from Eastman Chemical; or Adtac LV, Piccopale 100, Piccotac B, Piccotac 95 or Piccotac 115, products available from Hercules; or Hirkorez A-1100, A-1100S, C-1100, R-1100, R-1100S or T1080, all commercial products available from Kolon Chemical; or ADHM-100, a product available from Polysat. The resin may be an aromatic hydrocarbon resin such as Nevchem 70, 100, 110, 120, 130, 140 or 150, products available from Neville Chemical; or Escorez 7105 or 7312, commercial products available from ExxonMobil Chemical; or Hikotack P-90, P-90S, P-110S, P-120, P-120S, P-120HS, P-140, P-140M, P-150 or P-160, all commercial products available from Kolon Chemical; or Picco 1104, 2100, 5120, 5130, 5140, 6085, 6100, 6115 or 9140, or Piccodiene 2215 or Piccovar AP10, AP25 or L60, products available from Hercules. The resin may also be a coumarone indene resin such as Cumar P-10, P-25, R-1, R-3, R-5, R-6, R-7, R-9, R-10, R-11, R-12, R-13, R-14, R-15, R-16, R-17, R-19, R-21, R-27, R-28,R-29 or LX509, all commercial products available from Neville Chemical; or Natrorez10 or 25, products available from Natrochem; or Novares C30 or C160, commercial products available from Rutgers. The resin may be an ester of hydrogenated rosin such as Foral 85 or 105 or Pentalyn A or H or Hercolyn D or Stabelite Ester 10 or Abalyn, commercial products available from Hercules; or Komotac KF-462S, a product available from Momentum Technologies. Additionally, the tackifying resin component of the present invention may be mixtures of these or other suitable resins. The tackifying resin generally comprises from about 14% to about 40% by weight of the adhesive composition.

The pressure sensitive adhesive composition preferably contains an amorphous polyolefin, which functions as a flow modifier. The amorphous polyolefin may comprise amorphous polypropylene-ethylene copolymers such as E1003, E1060 or E100, commercial products available from Eastman Chemical. The amorphous polyolefin may also be an amorphous polypropylene/polypropylene-ethylene copolymer such as M1010, M1018, M1020, M1025 or M1030, commercial products available from Eastman Chemical. The amorphous polyolefin may be an amorphous polypropylene homopolymer such as P1010 or P1023, commercial products available from Eastman Chemical; or Polytac R-500, a commercial product available from Crowley Chemical. The amorphous polyolefin may be an amorphous polyethylene homopolymer such as Epolene C-10, C-13, C-14, C-15, C-17, N-10, N-11, N-14, N-15, N-20, N-21 and N-34, commercial products available from Eastman Chemical; or AC-6, AC-7, AC-8, AC-9, AC-617, AC-712, AC-715, AC-725, AC-735 or AC-1 702, commercial products available from Honeywell. The amorphous polyolefin may be an ethylene/vinyl acetate copolymer such as Elvax 40-W, 140-W, 150-W, 205-W, 210-W, 220-W, 240-W, 250-W, 260, 265, 310, 350, 360, 410, 420, 450, 460, 470, 550, 560, 650, 660, 670, 750, 760 or 770, commercial products available from DuPont. Additionally, the amorphous polyolefin may comprise mixtures of the above types. Generally, the amorphous polyolefin comprises about 0-50% by weight of the adhesive composition.

The adhesive composition may contain a compatible plasticizer. The plasticizer may also function as a tackifier and gives the composition its softness and high initial adhesivity. The plasticizer may also impart flame retardancy. Examples of suitable plasticizing agents include polybutene such as Indopol H-100, H-300, H-1500 or H-1900, commercial products available from Amoco Chemical; or Parpol 700, 950, 1300, 2200 or 2500, commercial products available from ExxonMobil Chemical; and chlorinated paraffin such as Chlorowax LV, 40, 41SW, 50, 45, 45-LV, 50-LV, 100, S-45, S-52, 500-C, 57-60, 60-70, or 70-200, commercial products available from Oxychem and mixtures thereof. The plasticizer generally comprises from about 30% to about 50% by weight of the adhesive composition.

The adhesive composition may also contain an antioxidant. Suitable antioxidants include, but are not limited to, Irganox 1010, 1076 or 1520, commercial products available from Ciba-Geigy; BNX-1010, a commercial product available from Mayzo, Inc.; or Wingstay C, K, L, S or T, commercial products available from Goodyear Tire & Rubber; or combinations thereof.

The adhesive composition may also contain a reinforcing agent. The reinforcing agent may be a hydrophilic fumed silica such as Aerosil 90, 130, 150, 200, 300 or 380, commercial products available from Degussa; or Cab-O-Sil H-5, HS-5, L-90, LM-130, LM-150, M-5, PTG, MS-55 or EH-5, commercial products available from Cabot. The reinforcing agent may comprise hydrophobic fumed silica such as Aerosil R202, R805, R812, R812S, R972, R974 or US202, commercial products available from Degussa; or Cab-O-Sil TS-530, TS-610 or TS-720, all commercial products available from Cabot. The reinforcing agent may be a hydrated amorphous precipitated silica such as Hi-Sil 132, 135, 210, 233, 243LD, 255, 532EP, 752, 900, 915 or 2000 from PPG Industries; or Hubersill 62, 162LR, 1612, 1633, 1714, 1743, 4151H, all commercial products available from J.M. Huber; or Garamite 1958 available from Southern Clay Products. Additionally, the reinforcing agent may be a combination of the reinforcing agents above.

The adhesive composition may contain a minor portion of pigments. The pigments may include titanium dioxide to make the product white or light in color or carbon black or coal filler to make the product black or dark in color and mixtures thereof.

The adhesive composition may further include a dessicant such as calcium oxide (lime), for example, Pulverized Quicklime, commercially available from Mississippi Lime Company, or similar products.

The adhesive composition may further include flame retardants such as antimony oxide or decabromodiphenyl oxide, commercially available from Albemarle under the designation Saytex 102E, or tetradecabromodiphenoxybenzene such as Saytex 120 available from Albermarle; or hexabromocyclododecane such as Saytex HP-900 available from Albermarle; or ethane-1,2-bis(pentabromophenyl) such as Saytex 8010 from Albermarle; or ethylenebistetrabromophthalimide such as Saytex BT-93 from Albermarle; and mixtures thereof.

The pressure sensitive adhesive composition of the present invention is generally prepared by mixing the components together in a conventional double-arm sigma blade mixer at a temperature of about 150° C. to about 205° C. until a homogenous mixture is obtained. The mixing time is generally about four hours. The resulting pressure sensitive adhesive composition exhibits a 180° peel strength at room temperature of at least 1270 grams per inch (g/in) (500 g/cm) when adhered to EPDM or TPO as measured by the ASTM D 3330 test method. Typically, the adhesive composition exhibits a 180° peel strength at room temperature of about 1905 g/in (750 g/cm) on EPDM and 2540 g/in (1000 g/cm) on TPO. The composition supports a static load of at least 50 grams/in² (8 g/cm²) at 70° C. for a minimum of 96 hours when bonded to any desired membrane substrate. The adhesive is suitable for use at temperatures between about −40° C. to 122° C.

The adhesive composition of the present invention does not require the use of organic solvents, and the adhesive poses no environmental hazard. Additionally, the adhesive resists water exposure. These properties make the adhesive composition useful for bonding roofing materials that are subject to extreme heat, cold, and water exposure. Generally, the overlapping surfaces of the sheets to which the adhesive composition is to be applied should be clean, dry, free of loose or foreign materials, and free of surface contaminants such as grease or oil.

To adhere together sheets of roofing materials, the adhesive composition is preferably hot applied to at least one overlapping edge of the sheets using any conventional means such as roll, slot die, spray, metering rod or extrusion coating. The adhesive is typically hot applied at a temperature between about 175° C. to 205° C. For purposes of defining and describing the present invention, it is noted that the roofing membranes may be comprised of materials that are used in the commercial and residential roofing industry as waterproofing membranes. Such materials include, but are not limited to, EPDM rubber, thermoplastic polyolefin (TPO), or reprocessed tire treads.

The adhesive is applied to the roofing membrane on at least one major face thereof. For convenience, the adhesive is preferably carried on a release liner. After application of the adhesive to the first roofing sheet, the release liner is removed and the overlapping edges of the roofing sheets are pressed together to ensure good contact of the adhesive to the sheet materials. The adhesive provides an immediate bond that resists weathering and heat aging. No special equipment is required during installation of the roofing article.

In order that the invention may be more readily understood, reference is made to the following examples of compositions within the scope of the present invention, which examples are intended to be illustrative of the invention, but are not intended to be limiting in scope.

### EXAMPLE 1

The compositions and amounts listed below were charged to a conventional double-arm sigma blade mixer and blended for a period of four hours. The resulting compositions were then hot applied to a tape at a temperature of between 175° C. to 205° C. The resulting compositions had high initial adhesivity and excellent tack. The compositions were measured to resist a dead load of 50 g at 70° C. for 96 hours. Pass indicates that there was no slippage.

Grams

| Compound Description | 1 | 2 | 3 | 4 |
|---|---|---|---|---|
| Block Copolymer | 325 | 325 | 325 | 350 |
| Polyisobutylene | 250 | 250 | 250 | 250 |
| Amorphous Polyolefin | 0 | 0 | 50 | 0 |
| Tackifiers | 650 | 525 | 525 | 525 |
| Plasticizer | 575 | 675 | 675 | 650 |
| Antioxidant | 10 | 10 | 10 | 10 |
| Reinforcing Agent | 15 | 15 | 15 | 15 |
| Pigment | 5.1 | 5.1 | 5.1 | 5.1 |
| Flame Retardant | 0 | 22 | 22 | 0 |
| Physical Properties | | | | |
| Dead Load 50 g on | Pass | Pass | Pass | Pass |
| EPDM @ 70° C. | | | | |
| Dead Load 50 g on | Pass | Pass | Pass | Pass |
| TPO @ 70° C. | | | | |

### EXAMPLE 2

The peel strength of composition 1 in Example 1 was measured. The adhesive was applied to a TPO roofing sheet membrane. The membrane was 2.54 cm wide (1 in) and about 15 cm long. The membrane to membrane 180° peel strength and shear strength were measured after various conditioning periods: (1) after 24 hours at room temperature (pulled at room temperature), (2) after 24 hours at 55° C. (pulled at room temperature), (3) after 24 hours at 55° C. (pulled at 55° C.), (4) after 24 hours at 70° C. (pulled at room temperature), and (5) after 24 hours at 70° C. (pulled at 70° C.) as reported below. The specimens were pulled at a rate of 5.08 cm (2 inches) per minute.

| | Peel Strength - g/in |
|---|---|
| | TPO to TPO sheet |
| Conditioning Period | membrane |
| (1) 24 hours at RT, pulled at RT | 3675 |
| (2) 24 hours at 55° C., pulled at RT | 2950 |
| (3) 24 hours at 55° C., pulled at 55° C. | 725 |
| (4) 24 hours at 70° C., pulled at RT | 3800 |
| (5) 24 hours at 70° C., pulled at 70° C. | 635 |

| | Shear Strength - g/in |
|---|---|
| | TPO to TPO sheet |
| Conditioning Period | membrane |
| (1) 24 hours at RT, pulled at RT | 7435 |
| (2) 24 hours at 55° C., pulled at RT | 6850 |
| (3) 24 hours at 55° C., pulled at 55° C. | 2540 |
| (4) 24 hours at 70° C., pulled at RT | 8345 |
| (5) 24 hours at 70° C., pulled at 70° C. | 2000 |

While certain representative embodiments and details have been shown for purposes of illustrating the invention, it will be apparent those skilled in the art that various changes in the methods and apparatus disclosed herein may be made without departing from the scope of the invention, which is not to be considered limited to what is described in the specification.

1. A hot melt pressure sensitive adhesive composition for adhering together roofing materials comprising:
a) a rubbery polymer comprising a blend of i) from about 10 to about 25% by weight of a thermoplastic block copolymer selected from the group consisting of a styrene-butadiene-styrene block copolymer, a styrene-isoprene-styrene block copolymer, a styrene-ethylene/butylene-styrene block copolymer, a styrene-ethylene/propylene block copolymer and an ethylene-propylene block copolymer and combinations thereof and ii) from about 5% to about 20% by weight polyisobutylene;
b) a compatible tackifier; and
c) an amorphous polyolefin.

2. The article as claimed in claim 1 wherein said thermoplastic block copolymer comprises from about 15 to 20% by weight of the total adhesive composition.

3. The article as claimed in claim 1 wherein said polyisobutylene comprises from about 10% to 15% by weight of the total adhesive composition.

4. The adhesive composition as claimed in claim 1 wherein said tackifier is selected from the group consisting of hydrogenated polyalicyclic resins, aliphatic hydrocarbon resins, aromatic hydrocarbon resins, coumarone indene resins, esters of hydrogenated rosins and combinations thereof.

5. The adhesive composition as claimed in claim 1 wherein said amorphous polyolefin is selected from the group consisting of amorphous polypropylene-ethylene copolymers, amorphous polypropylene/polypropylene-ethylene copolymers, amorphous polypropylene homopolymers, amorphous polyethylene homopolymers and combinations thereof.

6. The adhesive composition as claimed in claim 1 further comprising butyl rubber.

7. The adhesive composition as claimed in claim 1 further comprising an antioxidant.

8. The adhesive composition as claimed in claim 1 further comprising a compatible plasticizer.

9. The adhesive composition as claimed in claim 8 wherein said plasticizer is selected from the group consisting of polybutene, chlorinated paraffin and combinations thereof.

10. The adhesive composition as claimed in claim 1 further comprising a reinforcing agent.

11. The adhesive composition as claimed in claim 8 wherein said reinforcing agent comprises silica.

12. The adhesive composition of claim 1 further comprising a flame retardant.

13. The adhesive composition of claim 12 wherein said flame retardant is selected from the group consisting of antimony oxide, decabromodiphenyl oxide, tetradecabromodiphenoxybenzene, hexabromocyclododecane, ethane-1,2-bis(pentabromophenyl), ethylenebistetrabromophthalimide and combinations thereof.

14. The adhesive composition as claimed in claim 1 including a release liner adhered to said adhesive composition.

15. A first roofing membrane adhered to a second roofing membrane with an adhesive composition which provides a water tight seal, said adhesive composition comprising:
a) a rubbery polymer comprising a blend of i) a thermoplastic block copolymer selected from the group consisting of a styrene-butadiene-styrene block copolymer, a styrene-isoprene-styrene block copolymer, a styrene-ethylene/butylene-styrene block copolymer, a styrene-ethylene/propylene block copolymer and an ethylene-propylene block copolymer and combinations thereof and ii) a polyisobutylene; and
b) a compatible tackifier; wherein said adhesive composition exhibits 180° peel strength at room temperature of at least 500 grams/cm.

16. The article as claimed in claim 15 wherein said tackifier is selected from the group consisting of hydrogenated polyalicyclic resins, aliphatic hydrocarbon resins, aromatic hydrocarbon resins, coumarone indene resins, esters of hydrogenated rosins and combinations thereof.

17. The article as claimed in claim 15 wherein said adhesive composition further comprises an amorphous polyolefin.

18. The article as claimed in claim 17 wherein said amorphous polyolefin is selected from the group consisting of amorphous polypropylene-ethylene copolymers, amorphous polypropylene/polypropylene-ethylene copolymers, amorphous polypropylene homopolymers, amorphous polyethylene homopolymers and combinations thereof.

19. The article as claimed in claim 15 wherein said thermoplastic block copolymer comprises from about 10 to about 25% by weight of the total adhesive composition.

20. The article as claimed in claim 15 wherein said polyisobutylene comprises from about 5% to about 20% by weight of the total adhesive composition.

21. The article as claimed in claim 15 wherein said thermoplastic block copolymer comprises from about 15 to 20% by weight of the total adhesive composition.

22. The article as claimed in claim 15 wherein said polyisobutylene comprises from about 10 to 15% by weight of the total adhesive composition.

23. The article as claimed in claim 15 wherein said adhesive composition further comprises a compatible plasticizer.

24. The article as claimed in claim 15 wherein said adhesive composition further comprises butyl rubber.

25. The article as claimed in claim 13 wherein said adhesive composition supports a static load of at least 50 grams/in² at 70° C. for at least 96 hours.
